(19) United States
(12) Patent Application Publication
(10) Pub. No.: US 2008/0001937 A1
(43) Pub. Date: Jan. 3, 2008

(54) DISPLAY SUBSTRATE HAVING COLORABLE ORGANIC LAYER INTERPOSED BETWEEN PIXEL ELECTRODE AND TFT LAYER, PLUS METHOD OF MANUFACTURING THE SAME AND DISPLAY DEVICE HAVING THE SAME

(75) Inventors: Kyoung-Ju Shin, Gyeonggi-do (KR); Jin-Ho Ju, Seoul (KR); Shi-Yul Kim, Gyeonggi-do (KR); Jang-Soo Kim, Gyeonggi-do (KR); Chong-Chul Chai, Seoul (KR); Hye-Young Ryu, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/759,515

(22) Filed: Jun. 7, 2007

(30) Foreign Application Priority Data
Jun. 9, 2006 (KR) 10-2006-0051867
Nov. 21, 2006 (KR) 10-2006-0115107

(51) Int. Cl. G09G 5/00

(52) U.S. Cl. 345/204

(57) ABSTRACT

A display substrate includes a TFT layer, a passivation layer, an organic layer, an inorganic insulating layer and a pixel electrode. The TFT layer includes gate and data lines, a thin film transistor and a storage electrode. The data line crosses the gate line, and is electrically insulated from the gate line by a gate insulating layer. The TFT is electrically connected to the gate and data lines. The passivation layer covers the TFT layer. The organic layer is on the passivation layer. The inorganic insulating layer of a low temperature deposition is on the organic layer, and the low temperature is about 100° C. to about 250° C. The pixel electrode is on the inorganic insulating layer to be electrically connected to the TFT through a contact hole that is formed through the inorganic insulating layer, the organic layer and the passivation layer. The inorganic insulating layer helps to block leakage of impurities from the organic layer to layers above the inorganic insulating layer.

### CROSS-REFERENCE TO RELATED APPLICATIONS

The present application claims priority from Korean Patent Application No. 2006-51867, filed on Jun. 9, 2006, and Korean Patent Application No. 2006-115107, filed on Nov. 21, 2006, the disclosures of which are hereby incorporated herein by reference in their entireties.

### BACKGROUND

1. Field of Invention

The present disclosure of invention relates to flat panel displays such as Liquid Crystal Display (LCD) displays and more particularly to a display substrate structure that operates to reduce misalignment between pixel-electrodes and color filters of the display.

2. Description of Related Art

A conventional liquid crystal display (LCD) device includes a thin film transistors (TFT's)-containing substrate and a color filters-containing substrate that is spaced apart from the TFT's-containing substrate. Each of the TFT's-containing substrate and a color filters-containing substrate includes transparent areas, corresponding to pixel areas of the display. A liquid crystal material layer is interposed into the space between the TFT's-containing substrate and the color filters-containing substrate.

The conventional TFT's-containing substrate includes an insulating substrate, a plurality of signal lines, a plurality of thin film transistors (TFT's), and a plurality of pixel electrodes organized to drive adjacent liquid crystal material into a desired one of plural optical orientations for thereby creating desired lighting effects for a corresponding plurality of display pixels.

The conventional color filters-containing substrate includes a color filters layer and a common electrode. The color filters layer may include red (R), green (G) and blue (B) color filters arranged in sequence next to one another so as to define a color of a corresponding display pixel. The common electrode is spaced apart from, and faces the plurality of pixel electrodes on the TFT's-containing substrate.

Ideally, the red (R), green (G) blue (B) and/or other color filters of the color filters-containing substrate are perfectly aligned over the pixel-electrodes of the TFT's-containing substrate. However, if there is a noticeable degree of misalignment between the spaced apart TFT's and filters substrates due to assembly variances in mass production, an image display quality of the LCD device will tend to be deteriorated in accordance with the degree of misalignment between the TFTs-containing substrate and the color filters-containing substrate. Thus, if mass production variability results in substantial misalignment between the TFTs-containing substrate and the color filters-containing substrate, the image display quality of the LCD device will tend to be noticeably deteriorated.

In order to prevent such misalignment, a newer type of LCD device has been developed where the color filters are integrally disposed directly on the TFTs-containing substrate. This newer type of LCD device is sometimes referred to as a Colors-On-Array (COA) type of device.

However, when the materials of the Colors-On-Array (COA) type device are provided directly adjacent to the pixel-electrodes, impurities may be eluted from the color filters of the COA type device so as to pass through openings in the pixel-electrodes and migrate into the liquid crystal layer so that the liquid crystal material is polluted by these leaking-through impurities. Additionally, if an organic layer is formed under the pixel electrodes so as to help planarize the TFT's-containing substrate, the impurities can pass through the organic insulating layer to pollute the liquid crystal layer lying directly above the organic planarizing layer.

Furthermore, in order to compensate for misalignment in mass production, a width of a black-out matrix that is formed on the conventional color filters-containing substrate is typically increased by a tolerance margin given for the possible misalignment between the TFTs-containing substrate and the color filters-containing substrate, and as a result, a measure known as the aperture ratio (the ratio of light passing pixel area relative to blacked-out display area) is disadvantageously reduced. Also, the conventional color filters-containing substrate that has the black-out matrix integrated with the color filters typically requires an overcoating layer for planarizing the bottom surface of the color filters-containing substrate. As a result, light transmittance through display is disadvantageously decreased by the presence of the planarity-providing overcoating layer.

### SUMMARY

The present disclosure of invention provides a display substrate structure of the COA type that is capable of decreasing defects due to impurity leakage.

A display substrate structure in accordance with one aspect of the present disclosure of invention includes a thin film transistors-containing layer, a passivation layer, a colorable organic layer, an inorganic insulating layer and a pixel electrode. The thin film transistors-containing layer includes a plurality of gate lines, a data lines, thin film transistors and storage electrodes. The data lines cross with the gate lines, but are electrically insulated from the gate lines by a gate insulating layer. The thin film transistors electrically connect to respective ones of the gate lines and the data lines at the crossing areas of said lines. The passivation layer covers the thin film transistors layer. The colorable organic layer is disposed on the passivation layer. The inorganic insulating layer can be of a low temperature deposition type and is disposed on the organic layer for sealing against leakage by impurities of the organic layer into liquid crystal material above. The inorganic insulating layer can be one created by a low temperature deposition process carried out at about 100° C. to about 250° C. The pixel electrode is formed on the inorganic insulating layer so as to be electrically connected to the thin film transistor through a contact hole that is defined through the inorganic insulating layer, through the organic layer and through the passivation layer for direct connection with a drain terminal of the thin film transistor (TFT).

The organic layer may have an additional hole defined therethrough at the position of the storage electrode, and the pixel electrode may be partially overlapped with the storage electrode at the location of the second hole while having at least the inorganic insulating layer interposed thereat for preventing leakage from colorable organic layer of impurities.

The organic layer may function as a planarizing layer that planarizes a surface of the TFTs-containing substrate. Alternatively or additionally, the organic layer may function as a color filter that provides an optical bandpass function to light passing through a corresponding pixel area for the purpose of displaying a color image.

In one embodiment, the inorganic insulating layer may include a silicon oxide and/or a silicon nitride. The inorganic insulating layer may be deposited via CVD (chemical vapor deposition) at the low temperature of about 100° C. to about 250° C. A thickness of the inorganic insulating layer may be about 500 Å to about 2,000 Å. A thickness of the organic layer may be about 2.5 μm to about 3.5 μm.

A display substrate structure in accordance with another aspect of the present disclosure of invention includes a thin film transistors-containing layer, a passivation layer, a colored filters layer, a plurality of pixel electrodes and a light blocking layer. The thin film transistors-containing layer includes a plurality of gate lines, a plurality of data lines crossing with the gate lines but being electrically insulated from the gate lines by a gate insulating layer, a plurality of thin film transistors electrically connected to the gate lines and the data lines, and a plurality of storage electrodes. The passivation layer covers the thin film transistors layer. The colored filter layer is disposed on the passivation layer. The pixel electrodes are disposed on the color filters layer in positions corresponding to each of pixels. The light blocking layer is disposed on the thin film transistors layer, and is positioned to block passage of light in areas between adjacent pixels areas.

The color filters layer may include a plurality of color filters having different colors, and the light blocking layer may be on a boundary portion between adjacent color filters. The boundary portion between the adjacent color filters may have a recessed shape.

A method of manufacturing a display substrate in accordance with still another aspect of the present disclosure of invention is provided as follows. A pixel units layer including a plurality of pixel parts that are arranged in a matrix, is formed on a substantially transparent insulating substrate (e.g., glass or plastic). An organic layer is formed on the pixel units layer. An inorganic layer is formed on the organic layer. A plurality of pixel electrodes are formed on the inorganic insulating layer at positions corresponding to each of the pixel parts.

A display device in accordance with still another aspect of the present disclosure of invention includes a display substrate, an opposite substrate and a liquid crystal layer. The display substrate includes a pixel layer, a color filter layer, an inorganic insulating layer of a low temperature deposition and a pixel electrode. The pixel layer includes a plurality of pixel parts arranged in a matrix shape. The color filter layer is on the pixel layer, and a thickness of the color filter layer is about 2.5 μm to about 3.5 μm. The inorganic insulating layer is on the color filter layer, and the low temperature is about 500 Å to about 2,000 Å. The pixel electrode is on the inorganic insulating layer corresponding to each of the pixel parts. The opposite substrate faces the display substrate to be combined with the display substrate. The liquid crystal layer is interposed between the display substrate and the opposite substrate.

A display device in accordance with still another aspect of the present disclosure of invention includes a display substrate, an opposite substrate and a liquid crystal layer. The display substrate includes a thin film transistor layer, a passivation layer, a color filter layer, a pixel electrode and a light blocking layer. The thin film transistor layer includes a gate line, a data line crossing the gate line and electrically insulated from the gate line by a gate insulating layer, a thin film transistor electrically connected to the gate line and the data line, and a storage electrode. The passivation layer covers the thin film transistor layer. The color filter layer is on the passivation layer. The pixel electrode is on the color filter layer corresponding to each of pixels. The light blocking layer is on the thin film transistor layer. The light blocking layer is between adjacent pixels. The opposite substrate is combined with the display substrate, and includes a common electrode on a surface facing the display substrate. The liquid crystal layer is interposed between the display substrate and the opposite substrate.

According to one aspect the present disclosure of invention, impurities that may leak from the organic layer are blocked from eluting into the liquid crystal material layer due to an impermeable barrier presented by the inorganic layer. Thus, an afterimage effect that may be due to impurity leakage may be decreased, and an image display quality is improved. Also, because the light blocking layer is integrally formed in the TFTs-containing substrate in tight alignment with the color filters, an aperture ratio of the display may be increased above that possible in a conventional, non-COA type display.

### BRIEF DESCRIPTION OF THE DRAWINGS

The above and other aspects of the present disclosure of invention will become more apparent by describing in detail, various embodiments thereof with reference to the accompanying drawings, in which:

FIG. 1 is a plan view illustrating a display substrate in accordance with one embodiment of the present disclosure;

FIG. 2 is a cross-sectional view taken along a line I-I′;

FIG. 3 is a plan view illustrating a display substrate in accordance with another embodiment;

FIG. 4 is a flow chart illustrating a method of manufacturing the display substrate shown in FIG. 1;

FIGS. 5 to 9 are cross-sectional views illustrating a method of manufacturing the display substrate shown in FIG. 4;

FIG. 10 is a cross-sectional view illustrating a display device in accordance with another embodiment;

FIG. 11 is a cross-sectional view illustrating a display device in accordance with another embodiment; and

FIG. 12 is a plan view illustrating a display substrate shown in FIG. 11.

### DETAILED DESCRIPTION

In the drawings, the size and relative sizes of layers and regions may be exaggerated for clarity and thus are understood to not necessarily be to scale. It will be further understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers may refer to like or similar elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the disclosure of invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosure of invention.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

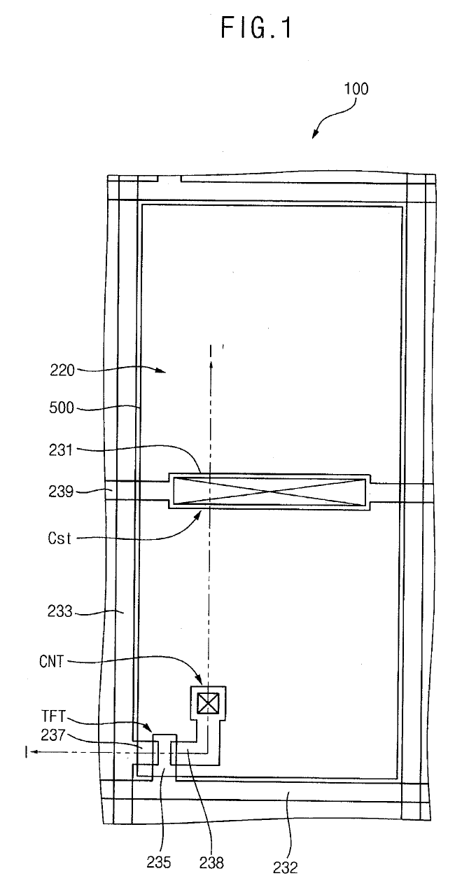

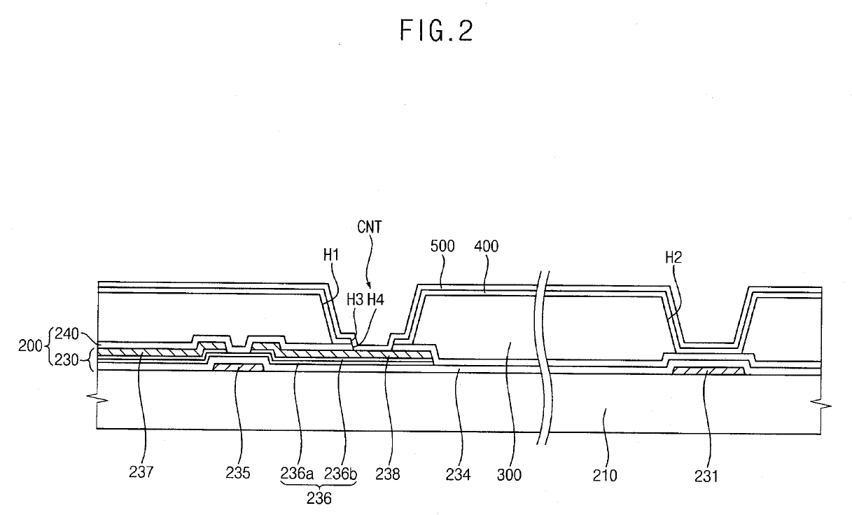

Referring to FIGS. 1 and 2, a display substrate 100 in accordance with the disclosure includes a pixel units layer 200, an organic layer 300, an inorganic insulating layer 400 and a pixel electrodes layer 500.

The pixel units layer 200 includes a plurality of pixel parts 220 that are arranged in a matrix on the insulating substrate 210. The insulating substrate 210 includes a transparent material. The transparent material may be glass for example.

The pixel units layer 200 includes a thin film transistors-containing layer 230 and a passivation layer 240. The thin film transistors-containing layer 230 is formed on the insulating substrate. The passivation layer 240 covers the thin film transistors-containing layer 230.

The thin film transistors-containing layer 230 includes a thin film transistor (TFT) and a charge storage electrode 231. The illustrated thin film transistor TFT and the storage electrode 231 correspond to one of the pixel parts 220.

The thin film transistors-containing layer 230 may further include a gate line 232 and a data line 233. The gate and data lines 232 and 233 may define a pixel area boundary for the corresponding pixel part 220. The data line 233 is electrically insulated from the gate line 232 by a gate insulating layer 234. The data line 233 crosses the gate line 232.

The gate line 232 is formed on the insulating substrate 210, and defines at least one of an upper boundary portion or lower boundary portion of the corresponding pixel area part 220.

The gate insulating layer 234 is formed on the insulating substrate 210 having the gate line 232 to cover the gate line 232. Examples of an insulating material that can be used for the gate insulating layer 234 include one or more of a silicon nitride, a silicon oxide, etc. The gate insulating layer 234 may be formed through a chemical vapor deposition (CVD) process. For example, a thickness of the gate insulating layer 234 may be about 3,000 Å to about 4,500 Å.

The data line 233 is formed on the gate insulating layer 234, and crosses the gate line 232 to define at least one of a left boundary portion and a right boundary portion of each of the pixel area parts 220.

The thin film transistor TFT is electrically connected to the gate line 232 and the data line 233, and is formed in each of the pixel parts 220. The thin film transistor TFT operates as a switch for selectively applying a data voltage that is transmitted from the data line 233 to the pixel electrode 500 based on a gate voltage that is transmitted through the gate line 232.

The thin film transistor TFT includes a gate electrode 235, an active layer 236, a source electrode 237 and a drain electrode 238.

The gate electrode 235 is electrically connected to the gate line 232, and functions as a control gate portion of the thin film transistor TFT.

The active layer 236 is formed on the gate insulating layer 234 to cover the gate electrode 235. The active layer 236 includes a semiconductor layer 236a and an ohmic contact layer 236b. For example, the semiconductor layer 236a includes conductively doped amorphous silicon (a-Si), and the ohmic contact layer 236b includes n+ doped amorphous silicon (n+a-Si). n+ impurities may be implanted into an upper portion of an amorphous silicon layer to form the ohmic contact layer 236b.

The source electrode 237 is formed on the active layer 236, and is electrically connected to the data line 233. The source electrode 237 functions as a source region of the thin film transistor TFT.

The drain electrode 238 is spaced apart from the source electrode 237 on the active layer 236. The drain electrode 238 functions as a drain region of the thin film transistor TFT. The drain electrode 238 is electrically connected to the pixel electrode 500 through a contact hole CNT that is formed through the passivation layer 240, the organic layer 300 and the inorganic insulating layer 400.

The source electrode 237 is spaced apart from the drain electrode 238 on the active layer 236, and a channel region is formed in the active layer 236 between the source and drain electrodes 237 and 238.

For example, an edge of the active layer 236 may be substantially the same as an outer edge of the data line 233, the source electrode 237 and the drain electrode 238 so that the edge of the active layer 236 may be overlapped with the outer edge of the data line 233, the source electrode 237 and the drain electrode 238.

The storage electrode 231 is electrically connected to a storage line 239, and is formed in each of the pixel parts 220. The storage electrode 231 and the storage line 239 may be formed from substantially the same layer as the gate line 232 and the gate electrode 235. The storage electrode 231 and the storage line 239 may include substantially the same material as the gate line 232 and the gate electrode 235. The storage electrode 231, the gate insulating layer 234, the passivation layer 240, the inorganic insulating layer 400 and the pixel electrode 500 form a storage capacitor Cst. The pixel electrode 500 is closely spaced to and faces the storage electrode 231. The gate insulating layer 234, the passivation layer 240 and the inorganic insulating layer 400 are interposed between the pixel electrode 500 and the storage electrode 231 so as to define a charge storage capacitor. The storage capacitor Cst helps to maintain an image voltage that is applied to the pixel electrode 500 through the thin film transistor TFT during one image defining frame period.

The passivation layer 240 is formed on the thin film transistor layer 230 having the thin film transistor TFT and the storage electrode 231. The passivation layer 240 includes an insulating material. Examples of the insulating material that can be used for the passivation layer 240 include a silicon nitride, a silicon oxide, etc. The passivation layer 240 may be formed through a high temperature deposition process of about 250° C. A thickness of the passivation layer 240 may be about 500 Å to about 2,000 Å.

The organic layer 300 is formed on the passivation layer 240. For example, the organic layer 300 planarizes a surface of the display substrate 100. The organic layer 300 may include a nonsensitive photoresist organic material. Alternatively or additionally, the organic layer 300 may include a coloring dye to display a color image. The color filter layer of the organic layer 300 may include a pigment or a colorant. For example, the color filter layer of the organic layer 300 may include a red color filter including a red colorant, a green color filter including a green colorant and a blue color filter including a blue colorant. The red, green and blue color filters may be arranged one after the other on the pixel layer 200. For example, the red, green and blue color filters may correspond to three rectangular the pixel parts 220, respectively arranged next to each other to define a square shaped and colored pixel area.

A thickness of the organic layer 300 may be increased to planarize the surface of the display substrate 100. For example, the thickness of the organic layer 300 may be about 2.5 μm to about 3.5 μm.

The organic layer 300 has a first hole H1 and a second hole H2 defined therethrough. The first hole H1 corresponds to the drain electrode 238 to form the contact hole CNT. The second hole H2 correspond to the storage electrode 231 to form the storage capacitor Cst.

The inorganic insulating layer 400 may be formed blanket-wise across substantially the entire surface of the insulating substrate 210 having the organic layer 300 so as to seal the organic layer 300. The inorganic insulating layer 400 substantially prevents impurities from eluting from the organic layer 300 and through an opened portion of the pixel electrode 500 (e.g., through a pin hole defect in the pixel-electrode or around an edge of the pixel-electrode) so as to infect overlying areas.

The inorganic insulating layer 400 is interposed between the organic layer 300 and the pixel electrode 500. The inorganic insulating layer 400 separates an alignment layer from the organic layer 300 through the opened portion of the pixel electrode 500 so that the alignment layer does not make direct contact with the organic layer 300. The alignment layer is on the inorganic insulating layer 400. Thus, the impurities that are eluted from the organic layer 300 including the photoresist organic material are not incident into the liquid crystal layer through the alignment layer so that the impurities do not react with the alignment layer of the organic layer 300.

The inorganic insulating layer 400 includes an inorganic material having low reactivity with an organic material to prevent the elution of the impurities. Examples of the inorganic material that can be used for the inorganic insulating layer 400 include one or more of a silicon oxide, a silicon nitride, etc.

The inorganic insulating layer 400 is deposited on the organic layer 300 at a low temperature such as about 100° C. to about 250° C. to prevent thermal deformation of the organic layer 400 including the photoresist organic material. For example, the inorganic insulating layer 400 may be formed through a chemical vapor deposition (CVD) process operating at about 160° C. to about 180° C.

A thickness of the inorganic insulating layer 400 is adjusted to block the impurities that are from the organic layer 300. For example, the thickness of the inorganic insulating layer 400 may be about 500 Å to about 2,000 Å.

The pixel electrode 500 may be formed on the inorganic insulating layer 400. The pixel electrode 500 corresponds to each of the pixel parts 220. The pixel electrode 500 includes a transparent conductive material that transmits light. Examples of the transparent conductive material that can be used for the pixel electrode 500 include indium zinc oxide (IZO), indium tin oxide (ITO), etc.

The pixel electrode 500 is electrically connected to the drain electrode 238 through the contact hole CNT. The contact hole CNT includes the first hole H1 that is formed through the organic layer 300, a third hole H3 that is formed through the inorganic insulating layer 400 and a fourth hole H4 that is formed through the passivation layer 240.

The pixel electrode 500 is partially overlapped with the storage electrode 231 on the second hole H2 of the organic layer 300, and the inorganic insulating layer 400, the passivation layer 240 and the gate insulating layer 234 are interposed between the pixel electrode 500 and the storage electrode 231. Thus, the storage capacitor Cst is formed by the pixel electrode 500, inorganic insulating layer 400, the passivation layer 240, the gate insulating layer 234 and the storage electrode 231.

According to the display substrate shown in FIGS. 1 and 2, the second hole H2 is formed through the organic layer 300 on the storage capacitor Cst so that a distance between the storage electrode 231 and the pixel electrode 500 is decreased, thereby increasing a capacitance of the storage capacitor Cst. In addition, the gate insulating layer 234, the passivation layer 240 and the inorganic insulating layer 400 are interposed between the storage electrode 231 and the pixel electrode 500 so that the storage capacitor Cst has a tri-layered dielectric structure. Thus, the storage capacitor Cst having the tri-layered dielectric structure has a lower defect than a storage capacitor having a double layered structure that includes a gate insulating layer and a passivation layer.

The pixel electrode 500 is typically formed individually for each of the pixel parts 220 so that the pixel electrode 500 is generally opened at its boundary between adjacent pixel parts 220. For example, the pixel electrode 500 is opened in a region corresponding to the gate and data lines 232 and 233. However, the inorganic insulating layer 400 covers the opened portion of the pixel electrode 500 to prevent the impurities of the organic layer 300 from eluting through the otherwise open gap between boundaries of adjacent pixel-electrodes.

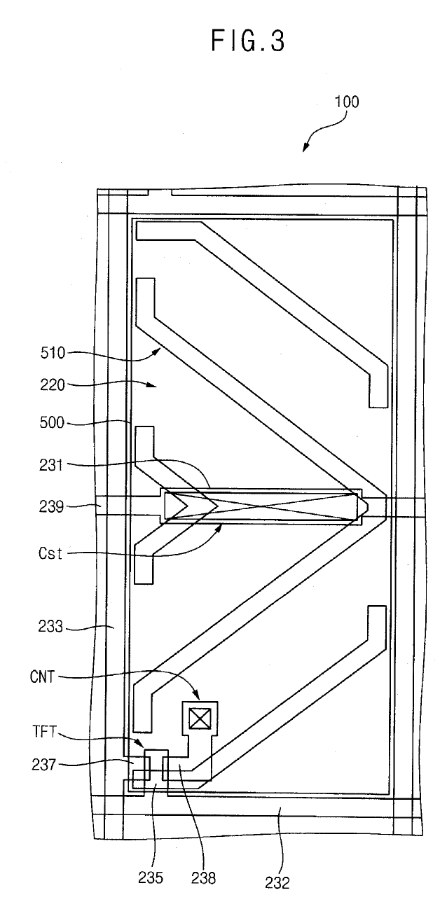

FIG. 3 is a plan view illustrating a display substrate in accordance with another embodiment. The display substrate of FIG. 3 is same as in FIGS. 1 and 2 except for the showing of a specific structure of a pixel electrode. Thus, the same reference numerals will be used to refer to the same or like parts as those described in FIGS. 1 and 2 and any further explanation concerning the above elements will be omitted.

Referring to FIG. 3, the illustrated pixel electrode 500 includes an opening 510 to divide each of pixel parts 220 into a plurality of domains. Liquid crystal molecules may arrange themselves in various different directions in the different domains (which are separated by the opening 510 of the pixel electrode 500) so that a viewing angle of a display device is increased. The opening 510 may have various shapes.

An inorganic insulating layer 400 covers an opened portion between adjacent pixel electrodes 500 and the opening 510 of the pixel electrode 500 to prevent impurities of an organic layer 300 from eluting. Thus it is possible to have various openings in the pixel-electrode besides that defined by the peripheral boundary of the pixel-electrode.

Hereinafter, a method of manufacturing a display substrate is described in detail.

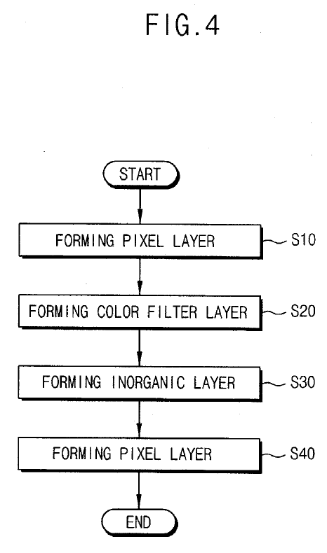

FIG. 4 is a flow chart illustrating a method of manufacturing the display substrate shown in FIG. 1.

Referring to FIGS. 1, 2 and 4, a pixel layer 200 including a plurality of pixel parts 220 is formed on an insulating substrate 210 (step S10). The pixel parts 220 are arranged in a matrix. An organic layer 300 is formed on the pixel layer 200 (step S20). An inorganic insulating layer 400 is formed on the organic layer 300 (step S30). A pixel electrode 500 corresponding to each of the pixel parts 220 is formed on the inorganic insulating layer 400 (step S40).

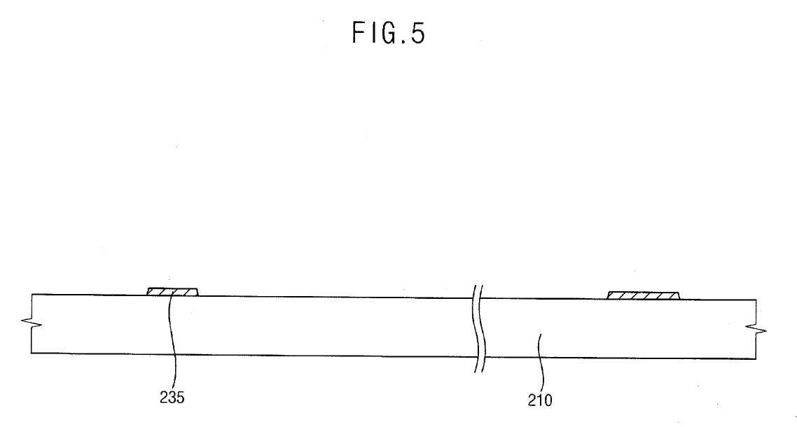

FIGS. 5 to 9 are cross-sectional views illustrating a method of manufacturing the display substrate shown in FIG. 4.

Referring to FIGS. 1 and 5, a first metal layer is deposited on an insulating substrate 210, and is partially etched to form a gate line 232, a gate electrode 235, a storage electrode 231 and a storage line 239. Examples of a conductive material that can be used for the first metal layer include chromium, aluminum, tantalum, molybdenum, titanium, tungsten, copper, silver, etc. These can be used alone, an alloy thereof or a combination thereof. The first metal layer may be deposited on the insulating substrate 210 through a sputtering process. Alternatively, a multi-layered metal layer may be deposited on the insulating substrate 210.

The gate line 232 defines an upper portion and a lower portion of each of the pixel parts 220. A gate electrode 235 is electrically connected to the gate line 232 to function as a gate terminal of a thin film transistor TFT. A storage electrode 231 functions as a lower electrode of a storage capacitor Cst.

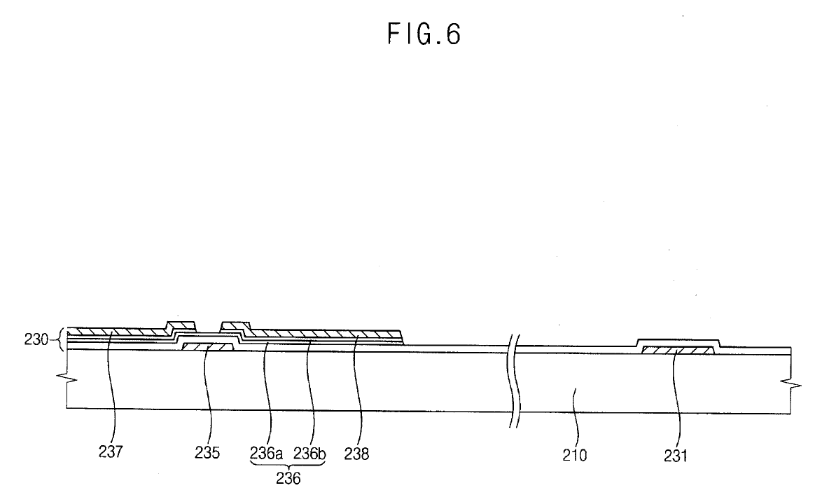

Referring to FIGS. 1 and 6, a gate insulating layer 234 is formed on the insulating substrate 210 including the gate line 232, the gate electrode 235, the storage electrode 231 and the storage line 239. Examples of an insulating material that can be used for the gate insulating layer 234 include silicon nitride, silicon oxide, etc. A thickness of the gate insulating layer 234 may be about 4,500 Å.

An amorphous silicon (a-Si) layer, an n+ amorphous silicon (n+a-Si) layer and a second metal layer are formed on the gate insulating layer 234, in sequence. The amorphous silicon (a-Si) layer, the n+ amorphous silicon (n+a-Si) layer and the second metal layer are partially etched through a photolithography process using a slit mask or a half tone mask to form an active layer 236, a data line 233, a source electrode 237 and a drain electrode 238. Thus, the active layer 236 may have substantially the same contour line as the data line 233, the source line 237 and the drain electrode 238.

The active layer 236 may include a semiconductor layer 236a and an ohmic contact layer 236b. The semiconductor layer 236a may include amorphous silicon, and the ohmic contact layer 236b may include n+ amorphous silicon. Examples of a conductive material that can be used for the second metal layer include chromium, aluminum, tantalum, molybdenum, titanium, tungsten, copper, silver, etc. These can be used alone, an alloy thereof or a combination thereof. The second metal layer may be deposited on the n+ amorphous silicon layer through a sputtering process. Alternatively, a multi-layered structure may be formed on the n+ amorphous silicon layer.

The data line 233 defines a left portion and a right portion of each of the pixel parts 220. The source electrode 237 is electrically connected to the data line 233 to function as a source terminal of the thin film transistor TFT. The drain electrode 238 is spaced apart from the source electrode 237 to function as a drain terminal of the thin film transistor TFT.

The active layer 236, the data line 233, the source electrode 237 and the drain electrode 238 may be formed using one mask. However, the active layer 236, the data line 233, the source electrode 237 and the drain electrode 238 may be formed using a plurality of masks.

The ohmic contact layer 236b interposed between the source and drain electrodes 237 and 238 are etched so that the semiconductor layer 236a is exposed between the source and drain electrodes 237 and 238. Thus, a channel may be formed in the semiconductor layer 236a between the source and drain electrodes 237 and 238. Therefore, a thin film transistor layer 230 is completed.

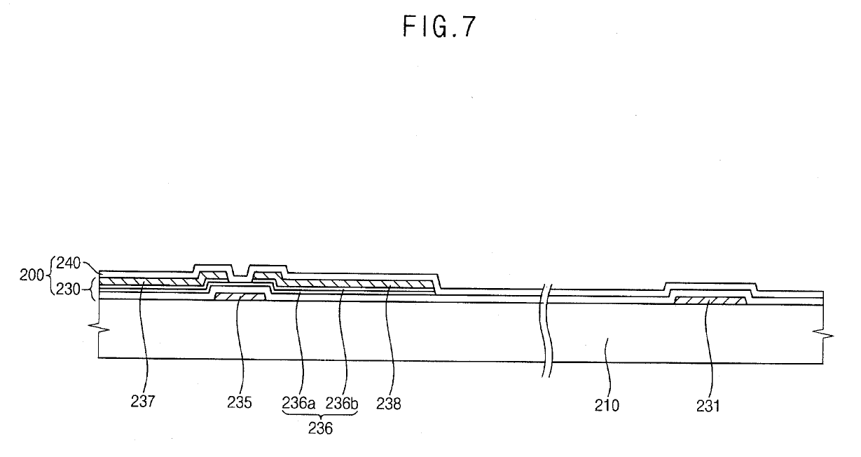

Referring to FIG. 7, a passivation layer 240 is formed on the thin film transistor layer 230. Examples of an insulating material that can be used for the passivation layer 240 include silicon nitride, silicon oxide, etc. The passivation layer 240 may be formed through a high temperature deposition process of about 250° C. For example, the passivation layer 240 may be formed through a chemical vapor deposition (CVD) method, and a thickness of the passivation layer 240 may be about 500 Å to about 2,000 Å. Thus, the pixel layer 200 is completed.

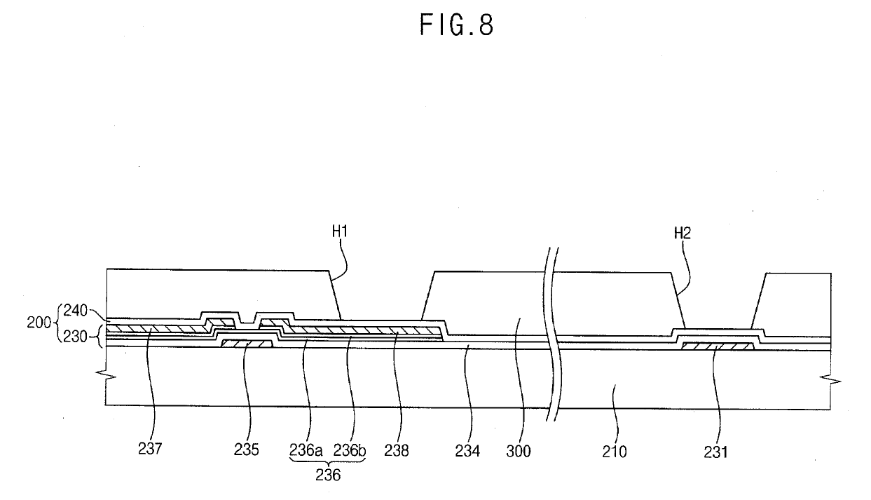

Referring to FIGS. 1 and 8, a photoresist organic film is formed on the passivation layer 240, and is patterned through a photo process to form an organic layer 300. Alternatively, the organic layer 300 may include a color photoresist having a photoresist organic material, a red colorant, a green colorant, a blue colorant, etc.

A thickness of the organic layer 300 is adjusted to planarize a surface of the display substrate 100. For example, the thickness of the organic layer 300 may be about 2.5 μm to about 3.5 μm.

A first hole H1 and a second hole H2 are formed in the organic layer 300 through a photo process. The first hole H1 is on the drain electrode 238 to form a contact hole CNT. The second hole H2 is on the storage electrode 231 to increase a capacitance of the storage capacitor Cst.

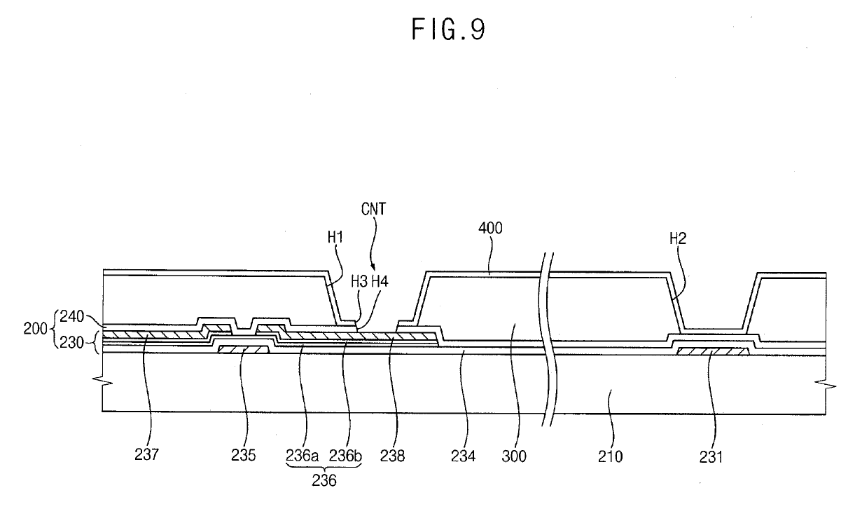

Referring to FIGS. 1 and 9, an inorganic insulating layer 400 is deposited on the organic layer 300. The inorganic insulating layer 400 prevents impurities that are from the organic layer 300 having a photoresist organic material from eluting. Examples of an inorganic material that can be used for the inorganic insulating layer 400 include a silicon nitride, a silicon nitride, etc.

The inorganic insulating layer 400 is deposited on the organic layer 300 at a low temperature of about 100° C. to about 250° C. to prevent a thermal deformation of the organic layer 300. For example, the inorganic insulating layer 400 may be formed through a chemical vapor deposition (CVD) process at a temperature of about 160° C. to about 180° C. In addition, the thickness of the inorganic insulating layer 400 is adjusted to prevent the impurities that are from the organic layer 300 from eluting. For example, a thickness of the inorganic insulating layer 400 may be about 500 Å to about 2,000 Å. A summation of the thickness of the passivation layer 240 and the thickness of the inorganic layer 400 may be about 1,000 Å to about 3,000 Å to increase a capacitance of the storage capacitor.

A third hole H3 and a fourth hole H4 are formed in the inorganic insulating layer and the passivation layer 240 through a photolithography process. The third hole H3 is connected to the first hole H1 of the organic layer 300. Thus, the contact hole CNT through which the drain electrode 238 of the thin film transistor TFT.

Referring to FIGS. 1 and 2, a transparent conductive layer is formed on the inorganic insulating layer 400. The pixel transparent conductive layer is partially etched through a photolithography process to form the pixel electrode 500 corresponding to each of the pixel parts 220.

The pixel electrode 500 includes a transparent conductive material that transmits light. Examples of the transparent conductive material that can be used for the pixel electrode 500 include indium zinc oxide (IZO), indium tin oxide (ITO), etc.

The pixel electrode 500 is electrically connected to the drain electrode 238 through the contact hole CNT. The contact hole includes the first hole H1, a third hole H3 and a fourth hole H4. The first hole H1 is formed in the organic layer 300. The third hole H3 is formed in the inorganic insulating layer 400. The fourth hole H4 is formed in the passivation layer 240. The pixel electrode 500 is partially overlapped with the storage electrode 231 in the second hole H2 of the organic layer 300, and the inorganic insulating layer 400, the passivation layer 240 and the gate insulating layer 234 are interposed between the pixel electrode 500 and the storage electrode 231, thereby forming a storage capacitor Cst. Thus, a capacitance of the storage capacitor Cst is increased, although an additional metal electrode is not formed between the storage electrode 231 and the pixel electrode 500.

Alternatively, the opening 510 (shown in FIG. 3) may be formed in the pixel electrode 500 through the photolithography process to divide each of the pixel parts 210 into a plurality of domains, thereby increasing a viewing angle of a display device.

According to the method shown in FIGS. 4 to 9, the inorganic insulating layer 400 covers the opened portion of the pixel electrode 500 to prevent the impurities from eluting from the organic layer 300.

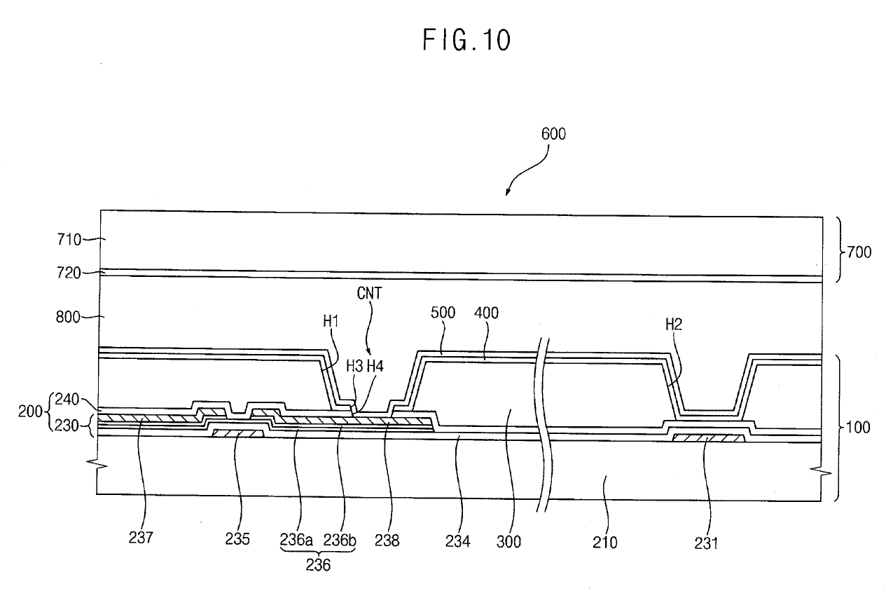

FIG. 10 is a cross-sectional view illustrating a display device in accordance with another embodiment of the present invention.

Referring to FIG. 10, the display device 600 includes a display substrate 100, an opposite substrate 700 and a liquid crystal layer 800. The opposite substrate 700 faces the display substrate 100, and is combined with the display substrate 100. The liquid crystal layer 800 is interposed between the display substrate 100 and the opposite substrate 700.

The display substrate of FIG. 10 is the same as in FIGS. 1 and 2. Thus, the same reference numerals will be used to refer to the same or like parts as those described in FIGS. 1 and 2 and any further explanation concerning the above elements will be omitted.

The opposite substrate 700 includes an insulating substrate 710 and a common electrode 720. The common electrode 720 faces a pixel electrode 500 of the display substrate 100. The liquid crystal layer 800 is interposed between the pixel electrode 500 and the common electrode 720.

The common electrode 720 includes a transparent conductive material that transmits light. The common electrode 720 may include substantially the same material as the pixel electrode 500. Examples of the transparent conductive material that can be used for the common electrode 720 include indium zinc oxide (IZO), indium tin oxide (ITO), etc.

The liquid crystal layer 800 may include liquid crystals arranged in a constant direction or in various different directions. The liquid crystals have various characteristics such as an anisotropic refractivity of an optical characteristics, an anisotropic permittivity of an electrical characteristics, etc. The liquid crystals vary arrangement in response to an electric field formed between the pixel electrode 500 and the common electrode 720, and light transmittance of the liquid crystal layer is changed. The common electrode 720 may have an opening to divide each of the pixel parts 220 into a plurality of domains.

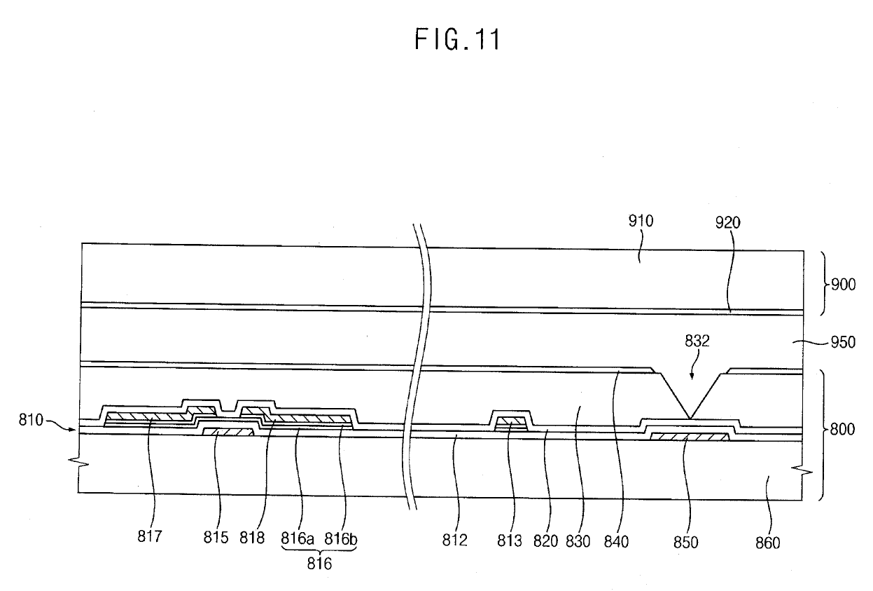

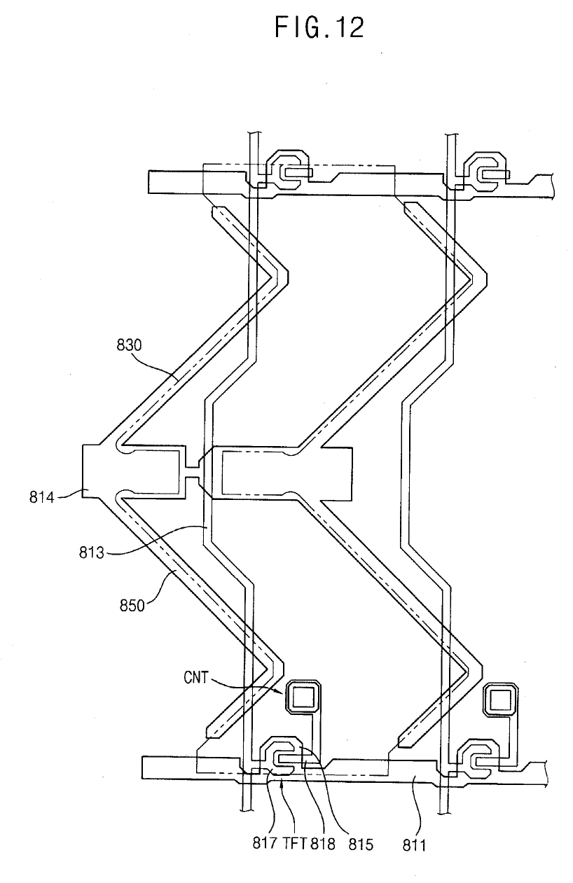

FIG. 11 is a cross-sectional view illustrating a display device in accordance with another embodiment of the present invention. FIG. 12 is a plan view illustrating a display substrate shown in FIG. 11.

Referring to FIGS. 11 and 12, the display device includes a display substrate 800, an opposite substrate 900 and a liquid crystal layer 950.

The display substrate 800 includes a thin film transistor layer 810, a passivation layer 820, a color filter layer 830, a pixel electrode 840 and a light blocking layer 850.

The thin film transistor layer 810 is formed on a transparent insulating substrate 860. For example, the insulating substrate 860 may include glass.

The thin film transistor layer 810 includes a gate line 811, a gate insulating layer 812, a data line 813, a thin film transistor (TFT) and a storage electrode 814.

The gate line 811 is formed in the insulating substrate 860. For example, the gate line 811 may be extended in a longitudinal direction of the insulating substrate 860.

The gate insulating layer 812 is formed on the insulating substrate 860 having the gate line 811 to cover the gate line 811. Examples of insulating material that can be used for the gate insulating layer 812 include a silicon nitride (SiNₓ), a silicon oxide (SiOₓ), a silicon oxinitride (SiOₓN_{y}), etc. For example, the gate insulating layer 812 may be formed through a chemical vapor deposition (CVD) process, and a thickness of the gate insulating layer 812 may be about 3,000 Å to about 4,500 Å.

The data line 813 is electrically insulated from the gate line 811 by the gate insulating layer 812. For example, the data line 813 is extended in a horizontal direction that crosses the extended direction of the gate line 811.

The thin film transistor TFT is electrically connected to the gate line 811 and the data line 813. At least one of the thin film transistors TFT is formed on each of pixels. The thin film transistor TFT applies a data voltage that is from the data line 813 to a pixel electrode 840 based on a gate voltage that is from the gate line 811.

The thin film transistor TFT includes a gate electrode 815, an active layer 816, a source electrode 817 and a drain electrode 818.

The gate electrode 815 is electrically connected to the gate line 811, and functions as a gate terminal of the thin film transistor TFT.

The active layer 816 is formed on the gate insulating layer 812 corresponding to the gate electrode 815. The active layer 816 includes a semiconductor layer 816a and an ohmic contact layer 816b. For example, the semiconductor layer 816a includes amorphous silicon (a-Si), and the ohmic contact layer 816b includes N+ amorphous silicon (N+a-Si) that is formed by implanting N+ impurities at a high concentration.

The source electrode 817 is formed on the active layer 816, and is electrically connected to the data line 813. The source electrode 817 functions as a source terminal of the thin film transistor TFT.

The drain electrode 818 is spaced apart from the source electrode 817 on the active layer 816, and functions as a drain terminal of the thin film transistor TFT. The drain electrode 818 is electrically connected to the pixel electrode 840 through a contact hole CNT that is formed through the passivation layer 820 and the color filter layer 830.

The source electrode 817 and the drain electrode 818 are spaced apart from each other on the active layer 816 to form a channel of the thin film transistor TFT in the active layer 816.

The data line 813, the source electrode 817, the drain electrode 818 and the active layer 816 are patterned using substantially the same etching mask, so that the active layer 816 may have substantially the same shape as the data line 813, the source electrode 817 and the drain electrode 818.

The storage electrode 814 is formed from substantially the same layer as the gate line 811 and the gate electrode 815, and includes substantially the same material as the gate line 811 and the gate electrode 815. The gate insulating layer 812, the passivation layer 820 and the color filter layer 830 are interposed between the storage electrode 814 and the pixel electrode 840 to form a storage capacitor Cst. Alternatively, a hole may be formed in the color filter 830 corresponding to the storage electrode 814, so that a distance between the storage electrode 814 and the pixel electrode 840 may be decreased, thereby increasing a capacitance of the storage capacitor Cst. The data voltage applied to the pixel electrode 840 through the thin film transistor TFT maintains during one frame by the storage capacitor Cst.

The passivation layer 820 is formed on the thin film transistor layer 810 that includes the gate line 811, the data line 813, the thin film transistor TFT and the storage electrode 814. The passivation layer 820 covers the thin film transistor layer 810 to protect and insulate the thin film transistor layer 810. Examples of insulating material that can be used for the passivation layer 820 include silicon nitride (SiNx), silicon oxide (SiOx), etc., and a thickness of the passivation layer 820 may be about 500 Å to about 2,000 Å.

The color filter layer 830 is formed on the passivation layer 820. The color filter layer 830 may include photosensitive-type organic material and an added colorant. For example, the color filter layer 830 may include a red color filter having red colorant, a green color filter having green colorant and a blue color filter having blue colorant. The red, green and blue color filters are uniformly arranged on the passivation layer 820. For example, the red, green and blue color filters correspond to rectangular subdivisions the square pixels, respectively.

The color filter layer 830 is sufficiently thick so that a surface of the display substrate 800 can be planarized. For example, a thickness of the color filter layer 830 may be about 2.5 μm to about 3.5 μm.

When the color filter layer 830 is formed in the display substrate 800, an overcoating layer for planarizing the display substrate 800 may be omitted so that light transmittance of the display device having the color filter layer 830 in the display substrate 800 may be greater than that of a display device having a color filter layer in the opposite substrate 900 by about 7%.

A boundary portion 832 between the color filters having different colors has a recessed shape. When the boundary portion between the color filters having the different colors has a protruded shape, liquid crystals of the liquid crystal layer 950 on the protruded boundary portion may be vertically aligned so that liquid crystals of the liquid crystal layer 950 adjacent to the light blocking layer 850 may be tilted by the vertically aligned liquid crystals, thereby leaking light adjacent to the light blocking layer 850. However, in FIGS. 11 and 12, sides of the color filters having different colors are spaced apart from each other so that the boundary portion 832 between the color filters having the different colors has the recessed shape. Thus, the liquid crystals of the liquid crystal layer 950 on the recessed boundary portion 832 are aligned toward a center of the light blocking layer 850 so that the light is not leaked adjacent to the light blocking layer 850.

The pixel electrode 840 is formed on the color filter layer 830 corresponding to each of the pixels. The pixel electrode 840 includes a transparent conductive material. Examples of the transparent conductive material that can be used for the pixel electrode 840 include indium zinc oxide (IZO), indium tin oxide (ITO), etc.

The pixel electrode 840 is electrically connected to the drain electrode 818 through the contact hole CNT that is formed through the color filter layer 830 and the passivation layer 820. In addition, the passivation layer 820 and the gate insulating layer 812 are interposed between the pixel electrode 840 and the storage electrode 814 to form the storage capacitor Cst.

The pixel electrode 840 has a zigzag shape that is aligned in the extended direction of the data line 813, thereby improving aperture ratio. Thus, the pixel electrode 840 is partially overlapped with the data line 813.

The pixel electrode 840 may have an opening pattern to increase a viewing angle. In addition, the pixel electrode 840 may be divided into a main electrode and a sub electrode to which voltages having different levels are applied, respectively. When the pixel electrode 840 is divided into the main and sub electrodes, two thin film transistors electrically connected to the main and sub electrodes, respectively, may be formed in each of the pixels.

The pixel electrode 840 is formed in each of the pixels, and a portion of the color filter layer 830 between adjacent pixel electrodes 840 is exposed between the adjacent pixel electrodes 840. Alternatively, an inorganic layer (not shown) may be formed on the exposed portion of the color filter layer 830 between the adjacent pixel electrodes 840 so that impurities may not be eluted from the color filter layer 830 toward the liquid crystal layer 950.

The light blocking layer 850 is formed in the thin film transistor layer 810 between the adjacent pixel electrodes 840. Thus, the light blocking layer 850 is in a region between adjacent pixels, which corresponds to the boundary portion 832 between the adjacent color filters, so that light incident into the region between the adjacent pixels is blocked, thereby increasing contrast ratio. For example, when a distance between the adjacent pixel electrodes 840 is about 8 μm, a width of the light blocking layer 850 may be no more than about 10 μm. When a black matrix is formed in the opposite substrate 900, the black matrix that is spaced apart from the display substrate 800, may require a width of about 12 μm for compensating misalignment between the display substrate 800 and the opposite substrate 900. Thus, aperture ratio of the display device having the light blocking layer 850 formed in the display substrate 800 is greater than that of the display device having the black matrix formed in the opposite substrate 900 by about 2%. In addition, optical difference between adjacent domains, which is caused by the misalignment between the display substrate 800 and the opposite substrate 900, is prevented, so that uniformity of an image display quality at various viewing angles is increased. Furthermore, the black matrix that is formed on the opposite substrate 900 is omitted so that an overcoating layer for planarizing the opposite substrate 900 having the black matrix may also be omitted. Thus, manufacturing cost is decreased, and luminance is improved.

The light blocking layer 850 may be formed from substantially the same layer as the gate line 811 and the storage electrode 814. Alternatively, the light blocking layer 850 may be formed from substantially the same layer as the data line 813.

The light blocking layer 850 may be electrically connected to the storage electrode 814 to which a common voltage is applied. Alternatively, the light blocking layer 850 may be spaced apart from the gate line 811 and the storage electrode 814 to remain floated.

The opposite substrate 900 is combined with the display substrate 800 to interpose a liquid crystal layer 950 between the opposite substrate 900 and the display substrate 800. The opposite substrate 900 includes an insulating substrate 910 and a common electrode 920 that is formed on a surface of the insulating substrate 910 facing the display substrate 800. The common electrode 920 includes a transparent conductive material that transmits light. Examples of the transparent conductive material that can be used for the common electrode 920 include indium zinc oxide (IZO), indium tin oxide (ITO), etc. The common electrode 920 may include substantially the same material as the pixel electrode 840. The common electrode 920 may have an opening pattern to increase a viewing angle.

The liquid crystal layer 950 includes the liquid crystals that have various electrical and optical characteristics such as anisotropy of refractivity, anisotropy of dielectric constant, etc. The liquid crystals of the liquid crystal layer 950 vary arrangement in response to the electric field formed between the pixel electrode 840 and the common electrode 920. Thus, light transmittance of the liquid crystal layer 950 is changed to display the image.

According to the present disclosure of invention, the inorganic insulating layer is blanket-wise formed across the substrate so as to substantially block impurities that are from the organic layer such as the color filter from reaching and polluting the liquid crystals. Also, an afterimage may be decreased. Thus, an image display quality of the display device is improved.

In addition, the gate insulating layer, the passivation layer and the inorganic insulating layer form the triple layered structure, and the triple layered structure is interposed between the storage electrode and the pixel electrode. Thus, shorting particles may not be interposed between the pixel electrode and the storage electrode, thereby decreasing a risk of short circuit between the pixel electrode and the storage electrode. Therefore, defects of the pixel parts are decreased.

Furthermore, the light blocking layer is formed from substantially the same layer as the gate metal or the data metal is formed in the display substrate, and the black matrix is omitted in the opposite substrate. Thus, the aperture ratio is increased, and the manufacturing cost is decreased.

Also, the conventional black matrix and the overcoating layer may be omitted in the opposite substrate so that the manufacturing cost is greatly decreased and the luminance is increased.

In addition, the boundary portion between the adjacent color filters has the recessed shaped to decrease the light leaking adjacent to the light blocking layer.

A disclosure of invention has been described with reference to various exemplary embodiments. It is to be understood however, that many alternative modifications and variations will be apparent to those having skill in the art in light of the foregoing description. Accordingly, the present disclosure embraces all such alternative modifications and variations as fall within the spirit and scope of the teachings provided herein.

What is claimed is:

1. A display substrate comprising:
a thin film transistors layer;
an organic layer disposed above the thin film transistors layer;
an inorganic insulating layer blanket-wise disposed above the organic layer so as to substantially seal the organic layer and prevent impurities from leaking out of the organic layer to layers above the inorganic insulating layer; and
a pixel electrode disposed on the inorganic insulating layer and electrically connected to a corresponding thin film transistor of the thin film transistors layer by way of a contact hole that is defined through the inorganic insulating layer.

2. The display substrate of claim 1, wherein the organic layer has a hole defined therethrough for positioning a charge storage electrode in close but spaced apart proximity to the pixel-electrode, and
the pixel electrode is partially overlapped with the storage electrode at the position of the hole and said inorganic insulating layer is interposed between the storage electrode and the pixel-electrode.

3. The display substrate of claim 2, wherein the thin film transistor comprises:
a gate electrode electrically connected to a gate line;
an active layer disposed on a gate insulating layer to cover the gate electrode;
a source electrode disposed on the active layer to be electrically connected to a data line; and
a drain electrode spaced apart from the source electrode on the active layer to be electrically connected to the pixel electrode.

4. The display substrate of claim 2, wherein the organic layer functions as a planarizing layer that substantially planarizes a surface of the display substrate.

5. The display substrate of claim 2, wherein the organic layer functions a color filter that passes through a predefined color band of light.

6. The display substrate of claim 5, wherein the inorganic insulating layer comprises at least one insulating material selected from the group consisting of a silicon oxide and a silicon nitride.

7. The display substrate of claim 6, wherein a thickness of the inorganic insulating layer is about 500 Å to about 2,000 Å.

8. The display substrate of claim 7, wherein a thickness of the organic layer is about 2.5 μm to about 3.5 μm.

9. The display substrate of claim 6, wherein the pixel electrode has an opening defined therethrough so as to operatively divide the pixel part into a plurality of crystal orientation domains each capable of supporting a different orientation of liquid crystals.

10. A method of manufacturing a display substrate comprising:
forming a pixel layer including a plurality of pixel parts arranged in a matrix on an insulating substrate;
forming an organic layer on the pixel layer;
forming an inorganic layer on the organic layer; and
forming a pixel electrode on the inorganic insulating layer corresponding to each of the pixel parts.

11. The method of claim 10, wherein the pixel layer is formed by:
forming a thin film transistor layer on each of the pixel parts, the thin film transistor layer including a thin film transistor and a storage electrode; and
forming a passivation layer on the thin film transistor layer.

12. The method of claim 10, wherein the organic layer is formed by:
forming a photoresist organic film on the passivation layer; and
forming a first hole corresponding to a drain electrode of the thin film transistor and a second hole corresponding to the storage electrode through a photolithography process.

13. The method of claim 12, wherein the photoresist organic film comprises a color photoresist including a colorant to display a color image.

14. The method of claim 12, wherein the inorganic insulating layer is formed by:
depositing the inorganic insulating layer on the organic layer through a low temperature deposition process of about 100° C. to about 250° C.; and
forming a third hole in the inorganic insulating layer corresponding to the first hole and a fourth hole in the passivation layer to form a contact hole through which the drain electrode of the thin film transistor is exposed.

15. The method of claim 14, wherein the inorganic insulating layer comprises an inorganic material selected from the group consisting of silicon oxide and silicon nitride.

16. The method of claim 14, wherein a thickness of the inorganic insulating layer is about 500 Å to about 2,000 Å.

17. The method of claim 16, wherein a thickness of the organic layer is about 2.5 μm to about 3.5 μm.

18. The method of claim 14, wherein the pixel electrode is formed by:
depositing a transparent conductive layer on the inorganic insulating layer; and
patterning the transparent conductive layer through a photolithography process to form the pixel electrode.

19. The method of claim 18, wherein the pixel electrode has an opening that divides each of the pixel parts into a plurality of domains.

20. A display device comprising:
a display substrate including:
a pixel layer including a plurality of pixel parts arranged in a matrix;
a color filter layer on the pixel layer, a thickness of the color filter layer being about 2.5 μm to about 3.5 μm;
an inorganic insulating layer of a low temperature deposition on the color filter layer, the low temperature being about 500 Å to about 2,000 Å; and
a pixel electrode on the inorganic insulating layer corresponding to each of the pixel parts;
an opposite substrate facing the display substrate to be combined with the display substrate; and
a liquid crystal layer interposed between the display substrate and the opposite substrate.

21. The display device of claim 20, wherein the opposite substrate comprises a common electrode facing the pixel electrode to interpose the liquid crystal layer.

22. A display substrate comprising:
a thin film transistor layer including:
a gate line;
a data line crossing the gate line, and being electrically insulated from the gate line by a gate insulating layer;
a thin film transistor electrically connected to the gate line and the data line; and
a storage electrode;
a passivation layer covering the thin film transistor layer;
a color filter layer on the passivation layer;
a pixel electrode on the color filter layer corresponding to each of pixels; and
a light blocking layer on the thin film transistor layer, the light blocking layer being between adjacent pixels.

23. The display substrate of claim 22, wherein the color filter layer comprises a plurality of color filters having different colors, and the light blocking layer is on a boundary portion between adjacent color filters.

24. The display substrate of claim 23, wherein the boundary portion between the adjacent color filters has a recessed shape.

25. The display substrate of claim 24, wherein the light blocking layer is formed from substantially a same layer as the gate line and the storage electrode.

26. The display substrate of claim 25, wherein the light blocking layer is electrically connected to the storage electrode.

27. The display substrate of claim 25, wherein the light blocking layer is spaced apart from the gate line and the storage electrode to remain floated.

28. The display substrate of claim 22, wherein a thickness of the color filter layer is about 2.5 μm to about 3.5 μm.

29. The display substrate of claim 22, wherein the pixel electrode has a zigzag shape aligned in an extended direction of the data line.

30. The display substrate of claim 29, wherein the pixel electrode is overlapped with the data line.

31. A display device comprising:
a display substrate including:
a thin film transistor layer including:
a gate line;
a data line crossing the gate line, and being electrically insulated from the gate line by a gate insulating layer;
a thin film transistor electrically connected to the gate line and the data line; and
a storage electrode;
a passivation layer covering the thin film transistor layer;
a color filter layer on the passivation layer;
a pixel electrode on the color filter layer corresponding to each of pixels; and
a light blocking layer on the thin film transistor layer, the light blocking layer being between adjacent pixels;
an opposite substrate combined with the display substrate, the opposite substrate including a common electrode on a surface facing the display substrate; and
a liquid crystal layer interposed between the display substrate and the opposite substrate.

32. The display device of claim 31, wherein the pixel electrode has a zigzag shape aligned in an extended direction of the data line to be overlapped with the data line.
